(19) United States
(12) Patent Application Publication
(10) Pub. No.: US 2006/0272889 A1
(43) Pub. Date: Dec. 7, 2006

(54) Safety restraint system

(76) Inventor: Denis Paquette, Wahnapitae (CA)

Correspondence Address: MARKS & CLERK, 1075 NORTH SERVICE ROAD WEST, SUITE 203, OAKVILLE, ON, L6M 2G2, CA

(21) Appl. No.: 10/554,210

(22) PCT Filed: Apr. 30, 2004
(86) PCT No.: PCT/CA04/00650

§ 371 Date: Oct. 24, 2005

Related U.S. Application Data
(60) Provisional application No. 60/470,870, filed on May 16, 2003.

(51) Int. Cl. A62B 35/00

(52) U.S. Cl. 182/3

(57) ABSTRACT

A safety restraint device and system are provided for establishing a fall arresting system for steel frame workers. The base unit of the devices can be rapidly attached to vertical steel I-beams by having a clamp for attachment to the beams. The base unit also has a mounting bracket to which a cable support accessory, for example, can be rapidly attached. The cable can then be extended and attached to similar devices on adjacent beams. Other accessories can also be used to provide temporary handrails, platforms and the like which are supported by the base units of the devices. A rapidly deployable system which provides improved worker safety is provided.

### FIELD OF THE INVENTION

The present invention relates to the field of safety restraint systems, and in particular, relates to fall arrest systems for use in framing operations.

### BACKGROUND OF THE INVENTION

Increasing government regulations regarding the safety of workers involved in framing operations, and in particular, steel beam framing operations, have heightened awareness of devices to be used as fall arresters in the event that a worker were to fail from the steel frame being construction.

The prior art devices are a significant improvement over safety restraint-free operations, but improvements over these systems is desired in order to ensure user safety while encouraging adherence to potential regulations mandating the use of safety restraint systems.

Variations of a commonly used safety restraint system are described in, for example, U.S. Pat. No. 5,029,670 (Whitmer), U.S. Pat. No. 5,863,020 (Olson et al.) and U.S. Pat. No. 6,173,809 (Cole et al.). All of the systems described therein utilize a system of “stanchions” attached to horizontal steel beams, to which horizontal static lines can be attached. The stanchions act to hold the static line at a height roughly 1 metre above the beam, but the ends of the static line are bolted, or otherwise attached to the horizontal beam. The stanchions also commonly act to vertically move the cable away from the beam so that a worker might walk on the beam without interference from the cable.

Typically, during the construction process, the building vertical steel-beams are placed into position. The horizontal beams are then lifted and place into position between the vertical beams where they are attached to the vertical beam. Prior to installation of the horizontal beam, the stanchions and clamping devices of Whitmer and the like, would be placed onto the beam so that they would be in position when the horizontal beam was fixed into place. As such, the system of stanchions and static lines are commonly attached to the horizontal beam while the beam is on the ground, and thus, prior to lifting the beam in place in the framing operation.

After the beam has been fixed into position, a lanyard line, attached to the worker, can then be attached to any of the static lines. Should the worker fall from the steel frame, his fall would be arrested by the various lines which ultimately are connected to the horizontal beam.

While this system has several desired safety features, it is a labour intensive operation and requires the workers to prepare each horizontal beam with stanchions and static lines prior to lifting the beam into place. Similarly, once the workspace has been enclosed, the stanchions and static lines must be removed, which again can take considerable time and effort.

An alternative system, described in Canadian patent publication No. 2208340 (Croteau et al.), published Dec. 20, 1998, describes a device for “sliding attachment to a flange of an I-beam”. Each worker uses a lanyard to attach themselves to the sliding device which moves as the worker moves along the beam. While avoiding the need for stanchions and static lines, this device must be removed and re-attached each time a work moves from beam to beam and could provide a safety hazard should the sliding device catch on an obstruction and fail to move with the worker.

An additional device, marketed as a Verticle Clamping Flangebar, available from SAF. Precision Manufacturing Ltd, uses a device which clamps to the flange of a vertical I-beam frame member. The device includes an anchor strap for attachment of a static line between the vertical frame members. While this device has advantages over the prior art system of attaching static lines to horizontal beams using stanchions, further improvements would be desirable. For example, the static lines used between the devices would need to custom fit for each application, and storage and reuse of such pre-cut static lines must be provided.

As such, it would be advantageous to provide an improved safety restraint system, attachable to vertical frame members, having improved versatility over the prior art systems.

### SUMMARY OF THE INVENTION

Accordingly, it is a principal advantage of the present invention that a safety restraint system which provides improved versatility over the prior art systems is provided.

It is a further advantage of the present invention that an improved safety restraint system having improved versatility which can be attached to vertical frame members, is also provided.

The advantages set out hereinabove, as well as other objects and goals inherent thereto, are at least partially or fully provided by the safety restraint system of the present invention, as set out herein below.

Accordingly, in one aspect, the present invention provides a safety restraint device comprising:

a base rod having attachment devices for temporarily affixing said base rod to a frame member;

one or more releasable mounting devices for receiving and attaching at least one of a variety of accessories to said base rod; and

optionally, at least one accessory for attachment to said releasable mounting device.

One or more optional accessories may also be affixed to the device, but alternatively, all accessories are removable, interchangable devices which can be added or removed from the releasable mounting device, as needed.

Further, the present invention also provides an accessory for use with a safety restraint device as described hereinabove, comprising a winch; a static line operatively connected to the winch; and a mounting attachment for attaching said winch accessory to said releasable mounting device.

In a further aspect, the present invention also provides a process for establishing a static line for a safety restraint system in a framing situation comprising:

separately attaching a first base rod and a second base rod to two vertical frame members;

mounting a static line containing accessory to said releasable mounting device on said first base rod;

extending a static line from said static line containing accessory and connecting it to said second base rod, so as to establish a static line between said base rods.

Preferably, the static line containing accessory comprises a winch with a locking mechanism so that the static line can be tightened between the base rods.

In a still further aspect, the present invention also provides for the use of the safety restraint device described hereinabove.

### DETAILED DESCRIPTION OF THE INVENTION

In the present application, the term “frame member” preferably refers to a I-beam used in the construction of a steel frame. As such, the present application is primarily directed to the use of safety restraint devices and systems of use in steel framing. However, the skilled artisan will be aware that the system and device may also be used in a wide variety of applications, including, for example, wood framing. Accordingly, while the present application is described with particular reference to the steel framing industry, the skilled artisan would be aware that the present application is equally applicable in other non-steel framing applications.

The terms “horizontal frame member” or “vertical frame member” refer to the orientation of the frame member in the building construction.

The base rod is preferably constructed of steel and may be of any appropriate shape and size. The attachment devices are preferably C-shaped or V-shaped brackets on the base rod adapted to be located on the flanges of the steel I-beam. At least one of the brackets is movable, relative to the other so that the attachment device can be clamped onto the I-beam. One or both of the attachment devices may be moved into, and then locked in place, through the use of pins, for example, which have been inserted through pre-drilled holes in the base rod, or the lice. Alternatively, all or part of the base rod might be threaded so that the attachment devices screwed into position and bolted into place.

In a preferred embodiment, the device also comprises an additional locking rod which is at least partially threaded, is connected to at least one of the attachment devices, and which is essentially parallel to the base rod. One end of the locking rod additionally comprises a crank handle, or an attachment point for attaching a cranking means, which cranking means could include, for example, a wrench or a specifically designed crank handle. As a result of the cranking means being turned, the attachment brackets move away from, or towards each other, and thereby grasp or release the I-beam.

The attachment devices may be further secured to the supporting beam or frame using one or more “set screws” which can be tightened through the attachment device(s) and onto the frame.

Thus, in a preferred embodiment, a base unit portion of the device of the present invention comprises a base rod, a locking rod, two attachment brackets with integral set screws. An optional crank handle is also preferably provided in order to establish a first component of the safety restraint device of the present invention. This first component is adapted to be locked into place on a horizontal, or preferably, a vertical frame member.

As a second component, the device of the present invention also provides for one or more releasable mounting devices for attaching at least one of a variety of accessories to the base rod, and preferably to the base unit. The mounting device is preferably an opening, such as, for example, a hole or a slot, in one end of the base rod into which an accessory can be inserted. The accessory can be threaded into the end of the base rod, but is preferably held in place using a locking pin, or the like, which would extend through, or into, the base rod and part of the accessory.

The mounting device might also be simply a threaded nut to which the accessory could be bolted.

In a preferred embodiment, a mounting device is located at each end of the base unit.

The accessory can be chosen from a wide variety of devices which might be of use during the construction process, and might include, for example, ladders, lights, signs, radios, handrails, platforms, suspended platforms or the like. However, in a preferred embodiment, the accessory comprises at least one winch assembly which contains a safety cable, and optionally an attachment point for a connecting a safety cable from a winch on a near-by or adjacent accessory on a second device.

Alternatively, the attachment point might be included as part of the base unit, and optionally, the accessory might comprise two, three or even more winch assemblies for use to establish two, three or more safety cables.

A particular advantage of the system of the present invention is that the base unit of the device can be attached to the vertical I-beams (or columns) of the frame of the building prior to the installation of the columns. Accordingly, while the vertical columns are still on the ground, the base units can be attached to the column at the appropriate heights. The column can then be raised and set in place. During construction, the horizontal beams are lifted without attachments and are fixed into position. The worker then only needs to insert a winch assembly with a safety cable into a base unit, extend the safety cable and attach it to the base unit (or accessory attached to a base unit) attached to an adjacent column, and tighten the cable using the winch. As such, a safety cable has been rapidly established to which the workers can attach their lanyards or the like.

The cable length can easily be varied depending on the particular application, and once construction has been sufficiently completed, the cable can be unhooked, rewound, and the winch accessory reused in another application of, potentially, different length. In the preferred embodiment, the base unit can also be rapidly removed from the I-beam by releasing the set screws, and using the crank to move the moveable bracket.

### BRIEF DESCRIPTION OF THE DRAWINGS

Embodiments of this invention will now be described by way of example only in association with the accompanying drawings in which:

FIG. 1 is a top view of a safety restraint device according to the present invention, containing a winch assembly accessory;

FIG. 2 is a front view of the device of FIG. 1;

FIG. 3 is a top view of an alternative embodiment of the device of the present invention;

FIG. 4 is a front view of the device of FIG. 3;

FIG. 5 is side view of an accessory of use in connection with the present invention;

FIG. 6 is a perspective view of, inter alia, the device of FIG. 3 in use with various other accessories, when used to establish a safety restraint cable system;

FIG. 7 is a perspective view of the use of the device of the present invention to provide a support for a ladder between floors of a construction operation; and

FIG. 8 is a perspective view of the use of the device of the present invention to provide support for a suspended platform.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

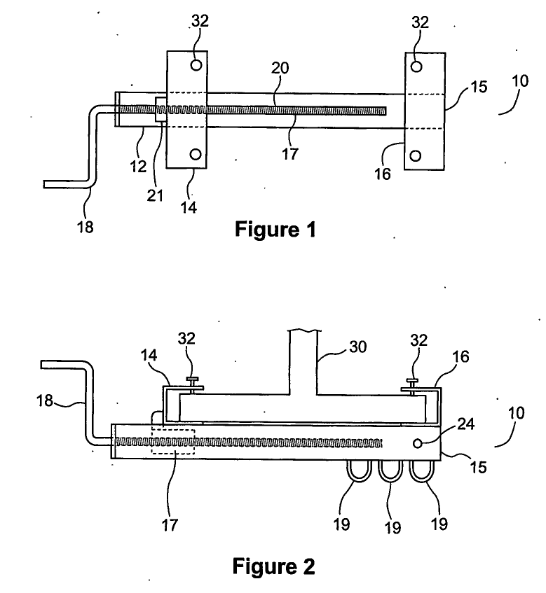

Referring to FIGS. 1 and 2, one embodiment of a safety restraint support device 10 is shown having a base rod 12, U-shaped attachment brackets 14 and 16, a crank handle 18 and a threaded locking rod 20.

In use, safety restraint support device 10 is operatively connected to a steel I-beam 30 (FIG. 2) by placing fixed attachment bracket 16, connected to one end of base rod 12, around one edge of the flange of I-beam 30. Movable attachment bracket 14, which is slidably connected to base rod 12, is moved into place around a second edge of the flange of I-beam 30 by rotating crank 18 and thus rotating threaded locking rod 20. As rod 20 turns, movable bracket 14 is moved, in base rod slot 17, towards fixed attachment bracket 16, and thus, device 10 is locked into position on I-beam 30. The rotation of locking rod 20 acts to cause traveler 21 to move within base rod 12, and thus acts to move the connected attachment bracket 14. In order to provide an additional locking feature, set screws 32 are adjusted so as to exert pressure on I-beam 30, and thus assist in preventing device 10 from any movement once locked into place.

One end 15 of end of base rod 12 is open and is adapted to receive the end of an accessory to be attached to safety restraint support device 10. Also included at said open end 15 is anchor hole 24 which extends through base rod 12 and which can be used for insertion of a locking pin (not shown) to hold an inserted accessory in place.

Also included in device 10 are attachment clips 19 to which ropes or cables can be connected.

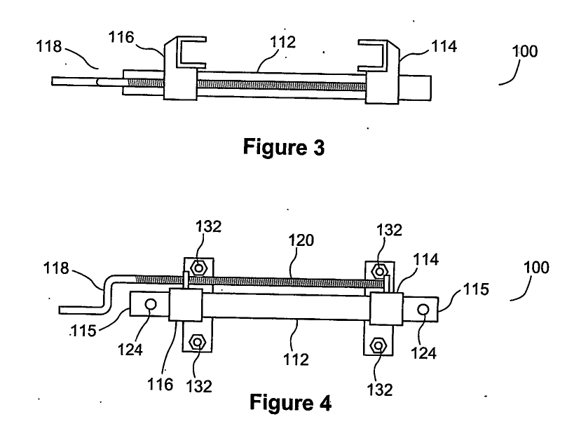

In FIGS. 3 and 4 an alternative embodiment of the present invention is shown wherein safety restraint support device 100 has a base rod 112 and a threaded locking rod 120 which is located outside of base rod 112. In this embodiment, locking rod acts by moving bracket 114, while bracket 116 is fixed in place. Similar to device 10, device 100 includes a crank handle 118 and set screws 132. In this embodiment, both ends 115 of base rod 112 are open and adapted to receive accessories which can be fixed in place using anchor holes 124.

The devices shown in FIGS. 1 to 4 are preferably made completely from steel, but might also be made from any ferrous or non-ferrous metal, plastic, graphite or composite materials, or combinations thereof and therebetween, provided that adequate strength properties are provided for the intended application.

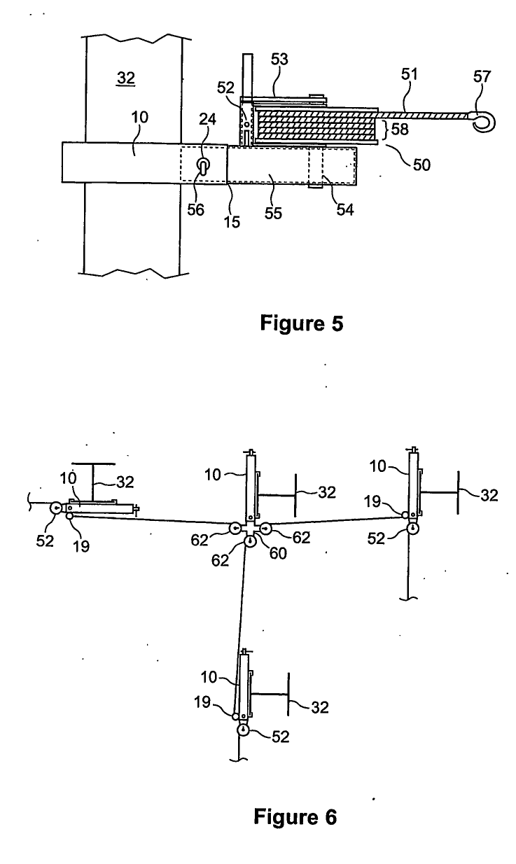

In FIG. 5, one possible accessory 50 is shown for attachment to a device 10, as shown in FIG. 1. Accessory 50 is a safety cable 51 contained within the reel 58 of a winch 52 which is attached to support member 55. Winch 52 has its own crank 53, and rotates about an axle 54 that extends through support member 55. Support member 55 is adapted to be inserted into end 15 of device 10, and is held in place by locking pin 56 which has been inserted through anchor hole 24. At one end of cable 51 is locking clip 57 for attachment to, for example, attachment clips 19 on an adjacent device.

Winch 52 contains a locking mechanism (not shown) so that after sufficient cable has been unwound from reel 58 and connected to clip 19, the winch can be used to pull the cable taut (or tight), and then locked into the tightened position. A suitable locking mechanism would include, for example, a rachet assembly, of the type known in the art.

In FIG. 6, an overview of one possible safety restraint arrangement, according to the present invention is shown having a series of vertical I-beams 32, which are 10 meters apart, to which a series of safety restraint devices 10, as shown in FIG. 1, have been attached. Winch assemblies 52, as shown in FIG. 5, have been attached to three of devices. An accessory 60, having a series of three winches 62, has been attached to a fourth device 10. In operation, cable is unwound from each of winches 62 and attached to clip 19 on the devices 10 on adjacent I-beams, and then drawn taut. As such, a cable system network has been provided to which workers can connect lanyards to act as fall arresters, while working.

The cable on winches 52 on the remaining devices can be used to extend the perimeter of safety cables and thus provide complete coverage of the working area.

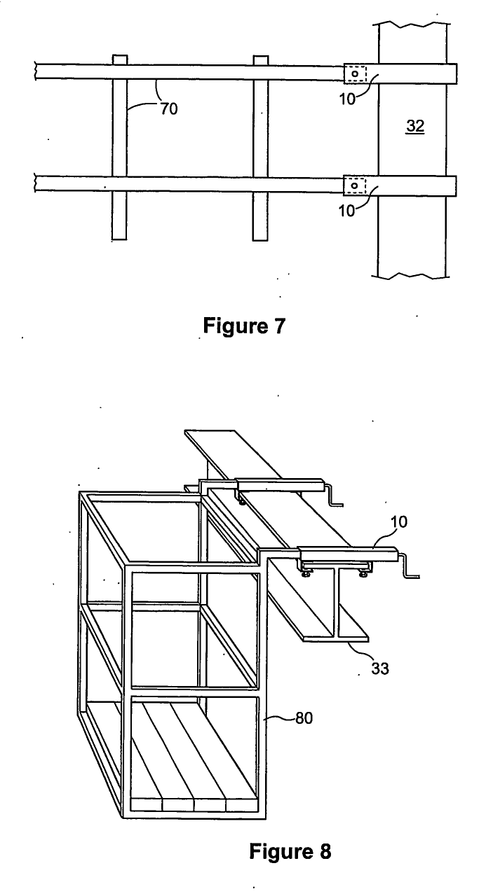

In FIG. 7, two devices 10 are attached to a vertical column 32 and are used to support a temporary handrail system 70. The other end of handrail 70 would be attached to additional devices (10), not shown. In FIG. 8, two devices 10 are shown which have been attached to a horizontal column 33 and are used to support a suspended platform 80.

As such, the versatility of the safety restraint system of the present invention is demonstrated.

Thus, it is apparent that there has been provided, in accordance with the present invention, a safety restraint system which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Further, while this discussion has addressed prior art known to the inventor, it is not an admission that all art discussed is citable against the present application.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Moreover, use of the terms “he”, “him”, or “his”, is not intended to be specifically directed to persons of the masculine gender, and could easily be read as “she”, “her”, or “hers”, respectively.

We claim:

1. A safety restraint device comprising:
a base rod having attachment devices for temporarily affixing said base rod to a frame member;
one or more releasable mounting devices for receiving and attaching at least one of a variety of accessories to said base rod; and
optionally, at least one accessory for attachment to said releasable mounting device.

2. A safety restraint device as claimed in claim 1 wherein said accessory is one or more removable, interchangable devices which can be added or removed from the releasable mounting device.

3. A safety restraint device as claimed in claim 1 wherein said accessory comprises a winch assembly having a winch; a static line operatively connected to the winch; and a mounting attachment for attaching said winch accessory to said releasable mounting device.

4. A safety restraint device as claimed in claim 3 wherein said winch comprises a locking mechanism so that the static line can be drawn tight using said winch, and maintained in a tightened condition.

5. A safety restraint device as claimed in claim 4 wherein said locking mechanism is a rachet assembly.

6. A safety restraint device as claimed in claim 2 wherein said accessory comprises 2 or 3 winch assemblies.

7. A safety restraint device as claimed in claim 1 comprising two releasable mounting devices for receiving and attaching at least one of a variety of accessories to said base rod.

8. A safety restraint device as claimed in claim 1 wherein said accessory is a winch assembly, a ladder, a light, a sign, a radio, a handrail, a platform, or a suspended platform.

9. A safety restraint device as claimed in claim 1 wherein said accessory is attached to said releasable mounting device using a lock pin.

10. A safety restraint device as claimed in claim 1 wherein said attachment devices are two C-shaped or V-shaped attachment brackets.

11. A safety restraint device as claimed in claim 10 additionally comprising a threaded locking rod operatively connected to at least one of said attachment brackets, and a crank connected to one end of said locking rod, so that turning of the crank results in relative movement of said attachment brackets.

12. An accessory for use with a safety restraint device as claimed in claim 1 comprising a winch assembly, a ladder, a light, a sign, a radio, a handrail, a platform, or a suspended platform.

13. An accessory as claimed in claim 12 comprising a winch assembly having a winch, a static line operatively connected to said winch, and having a mounting attachment for attaching said accessory to said safety restraint device.

14. A process for establishing a static line for a safety restraint system in a framing situation comprising:
separately attaching a first base rod and a second base rod to two vertical frame members;
mounting a static line containing accessory to said releasable mounting device on said first base rod;
extending a static line from said static line containing accessory and connecting it to said second base rod, so as to establish a static line between said base rods.

15. A process as claimed in claim 14 wherein said base rods are attached to said vertical frame members while said vertical frame members before installation of said vertical frame members into a vertical position.

16. The use of a safety restraint device as claimed in claim 1.
